(19) United States
(12) Patent Application Publication
(10) Pub. No.: US 2025/0116498 A1
(43) Pub. Date: Apr. 10, 2025

(54) WHEEL BASE SYSTEM WITH MAGNETIC ENCODER

(71) Applicant: Asetek Danmark A/S, Svenstrup J (DK)

(72) Inventor: Anders Daniel RASMUSSEN, Herlev (DK)

(21) Appl. No.: 18/907,293

(22) Filed: Oct. 4, 2024

(30) Foreign Application Priority Data
Oct. 6, 2023 (DK) PA202330249

(51) Int. Cl. G01B 7/30; A63F 13/57; G01D 5/14

(52) U.S. Cl. CPC G01B 7/30; A63F 13/57; G01D 5/145

(57) ABSTRACT

A wheel base system with magnetic encoder is disclosed. The wheel base system for simulation may comprise a motor which may comprise a rotor and a stator. The rotor may comprise a magnet and a first set of one or more electrical conducting wires. The rotor may be arranged to rotate around a rotor axis and rotate relative to the stator. The stator may comprise a second set of one or more electrical conducting wires. A magnetic sensor may be arranged statically relative to the stator. The wheel base system may have at least one wire of the first set of one or more electrical conducting wires being electrically connected to a wire of the second set of one or more electrical conducting wires. The magnetic sensor may be arranged to detect the absolute angular position of the magnet. The magnetic sensor thereby may be an absolute magnetic encoder.

### FIELD OF THE INVENTION

This invention is related to wheel base systems for simulation racing and for coupling to a steering wheel.

### BACKGROUND

The present disclosure relates to a wheel base system with a rotational sensor. For simulation racing, a driver uses a steering wheel to control the simulation which may be displayed on a display. Therefore, the setup for the simulation system needs to be able to have input sensors in the steering wheel and the signals from these sensors need to be communicated to a processing unit. At the same time the absolute rotation angle of the steering wheel needs to be detected which is solved in wheel base systems today by using multiple expensive incremental magnetic and optical encoders.

For wheel base systems information about how the rotating part is positioned and how fast the part is rotating may be advantageous to know as discussed in the following. Different methods for detecting the rotational position of a rotational object are known in the art and use different encoders.

One example of a system including a slip ring and an encoder that measures the rotation of a part of the slip ring can be found in patent U.S. Pat. No. 6,908,310B1. The system of U.S. Pat. No. 6,908,310B1 incorporates an incremental magnetic encoder to track rotational movement. However, incremental encoders require calibration each time they are powered. In certain motor types, such as stepper motors or servo motors, incremental encoders are employed to monitor the position of the driving shaft.

In simulation racing, the rotational position of the steering wheel is crucial for controlling the simulation, as users require accurate feedback corresponding to the turning of the wheel. Various methods exist for measuring the rotational position of a steering wheel, but most solutions capable of measuring the angle of the steering wheel involve complex configurations and numerous components, leading to high production costs for simulation wheel bases. Consequently, there is a need for a simple and cost-effective solution for measuring the angle of a steering wheel using electrical connections.

The aforementioned known solutions and technologies in slip rings with rotational sensors encompass traditional slip rings, rotary encoders, resolver-based designs, miniaturized versions, non-contact or wireless slip rings, integration with digital communication, and multi-functional slip rings.

In light of the existing technologies, the present disclosure aims to introduce novel improvements and embodiments that address the limitations and challenges associated with slip rings and rotational sensors in wheel bases.

### A SUMMARY OF THE INVENTION

A first aspect of this disclosure is a wheel base system for simulation. The wheel base system may comprise a motor, which may comprise a rotor and a stator. The rotor may comprise a magnet and a first set of one or more electrical conducting wires. The rotor may be arranged to rotate around a rotor axis and rotate relative to the stator. The stator may comprise a second set of one or more electrical conducting wires. A magnetic sensor may be arranged statically relative to the stator. The wheel base system may have at least one wire of the first set of one or more electrical conducting wires being electrically connected to a wire of the second set of one or more electrical conducting wires. The magnetic sensor may be arranged to detect the absolute angular position of the magnet. The magnetic sensor thereby may be an absolute magnetic encoder.

An absolute angular position is a position between 0° and 360° defining the angle of rotation of an object around an axis. In this case, the angular position of a magnet is detected by a magnetic sensor which results in the angle of rotation between the magnet and the magnetic sensor. The system may be calibrated to define what no rotation of the magnet is, meaning what 0° is, i.e., relative to which position rotation is described. When the system has been calibrated once this calibration is enough for the wheel base system to be calibrated every time the system is powered on. A new calibration is needed if the magnet or the magnetic sensor are rearranged or replaced.

An absolute magnetic encoder is capable of detecting the absolute position of a magnetic element. Contrary to an absolute magnetic encoder an incremental magnetic encoder can be used. An incremental magnetic encoder can detect changes of the angular position of an object in steps, e.g., it may be determined when a rotating object is at one of a plurality of predefined angular reference position, but it cannot be determined where it is between these predefined reference positions. An incremental encoder needs to be calibrated every time the system is powered on as only incremental angular steps can be detected and the rotor may have rotated during a power off of the incremental sensor, thus a calibration point needs to be set every time the incremental sensor is powered on. This calibration may be done using other sensors like a light sensor or another magnetic sensor.

Having a wheel base system capable of detecting the absolute angular position of the rotor relative to the stator provides a system that no matter how many rounds the rotor has turned the system can detect the absolute angular position of the rotor. Thus, the wheel base system is ideal for simulation of racing vehicles where the angle of the steering wheel is needed to provide a realistic response in the simulation according to the handling of the steering wheel of a user.

It is possible that the sensor is not powered continuously, and the system is normally turned off after use, thus it is beneficial to have an absolute angular detecting system provides a robust system that does not need to be recalibrated every time the system is powered on. Furthermore, the wheel base system can transmit electrical signals from one set of wires to another set of wires while the two sets of wires can rotate relative to each other without any of the wires getting twisted, thus, the wheel base system can transmit electrical signals from a steering wheel wired to a processing unit controlling a simulation. For a simulation of a car, the driver turns the steering wheel and the simulation can provide feedback on the control of the steering wheel based on the angular measurements collected by the wheel base system.

In embodiments, the wheel base system is a simulation system for simulation of vehicles. The simulation system may comprise all parts of the wheel base system. The simulation system may be said to comprise a wheel base.

In embodiments, the center of the magnetic sensor is positioned with a maximum distance to the rotor axis such as 3 mm, 4 mm, 5 mm, 6 mm, 7 mm, 8 mm, 9.5 mm, 10 mm, 13 mm, 16, mm, 20 mm, 25 mm, and 30 mm.

By having the magnetic sensor positioned within a distance of the rotor axis the magnetic sensor may be able to detect the magnetic field of the magnet of the rotor with a better precision and the angular position of the rotor may be determined more precisely.

In embodiments, the rotor comprises a coupler for connecting a steering wheel for simulation. Thereby, the wheel base system is completely ready for use in a simulation setup where a user is to simulate driving a vehicle like a racing car. The coupler may be any coupler for different types of steering wheels. The steering wheel may be connected to the coupler by bolts, screw, or by a clicking mechanism to fixate the steering wheel on the coupler. The coupler may comprise electrical pins for connecting to the steering wheel like pogo pins. Alternatively, the electrical coupling can be separate from the coupler such as two plugs to connect the wires.

In embodiments, the wheel base system may comprise a steering wheel coupled to the coupler of the rotor.

In embodiments, the first set of electrical conducting wires are connected to one or more buttons of the steering wheel.

In embodiments, the relative positioning of the magnetic sensor and the magnet is such that for all rotational positions of the magnet around the rotor axis, the sensor will detect a magnetic field from the magnet with a signal-to-noise-ratio above one.

By arranging the magnet and the magnetic sensor such that a signal from the magnet can be measured with a signal-to-noise-ratio above one it is ensured that the measured signal from the magnetic sensor is based on the magnetic field from the magnet and the angular detection is ensured to be based on a signal from the magnet and not random noise from other sources.

In embodiments, the magnetic sensor is positioned on the rotor axis in a manner such that the rotor axis intersects with the magnetic sensor.

In embodiments, the magnetic sensor may be positioned off axis of the rotor axis in a plane perpendicular to the rotor axis and intersect the magnet.

Having the magnetic sensor positioned off axis, the wheel base system is easier to manufacture and the elements of the wheel base are simpler to assemble. If the magnet was to be placed on axis the magnet had to be placed on the slip ring, and thus aligned by the slip ring manufacturer. By having the magnet attached to the rotor of the wheel base system and not necessarily any of the slip ring elements, the magnet must be aligned with the rotor axis, but the slip ring elements do not need to be completely aligned. Thus, the wheel base system is easier to manufacture and costs less to manufacture.

In embodiments, the magnet is positioned on the rotor axis and positioned such that a magnetization axis of the magnet is perpendicular to the rotor axis.

The magnetization axis of a magnet is the axis along the direction that most of the magnetic dipoles of the magnet are pointing along. Thus, the magnetization axis is usually the axis along the line from the north pole of a magnet to the south pole.

In embodiments, the wheel base system comprising a plurality of individual magnetic hall sensors is arranged in an array.

Using multiple magnetic sensors will provide a wheel base system that can detect the angular position of the magnet with a higher precision.

In embodiments, the magnetic sensor and the magnet may be arranged such that at least a part of the area of the magnet projected onto the magnetic sensor along the rotor axis is for any position of the rotor encompassed by the area of the magnetic sensor.

In embodiments, the wheel base system comprises a PCB, the PCB being arranged statically relative to the rotor axis, the magnetic sensor being integrated on the PCB.

In embodiments, the slip ring comprises electrical shielding.

A second aspect of the disclosure is a method for detecting the angle of the rotor of a wheel base system, the method comprising the steps of:
measuring the magnetic field strength of the magnet of the wheel base system using a magnetic sensor and transmitting the collected data signal to a processor.
determining an absolute angular position of the magnet and the rotor based on the collected data signal.

In embodiments, the method further comprises the step of using the collected data signal to control a simulation of a vehicle.

By using the method for detecting the absolute angle of a rotating part of a wheel base system the system can be used for simulations of cars.

In an embodiment, the method further comprises the step of providing feedback in a simulation based on the absolute angular position.

In an embodiment, the simulation is a simulation for driving a car.

In an embodiment, the method further comprises the step of providing feedback in a simulation based on the signal.

A third aspect of the present disclosure is a first part of a wheel base system and relates to the slip ring elements and the magnetic encoder of the wheel base system. The part of the wheel base system comprising a rotor comprising a first set of one or more electrical conducting wires, the rotor arranged to rotate around a rotor axis, a stator comprising a second set of one or more electrical conducting wires, a magnet, the magnet being arranged to rotate around the rotor axis, a magnetic sensor, the magnetic sensor being arranged statically relative to the stator. At least one wire of the first set of one or more electrical conducting wires may be electrically connected to a wire of the second set of one or more electrical conducting wires. The magnetic sensor may be arranged to detect the absolute angular position of the magnet, the magnetic sensor thereby being an absolute magnetic encoder.

Having a first part capable of detecting the absolute angular position of the rotor relative to the stator provides a system that no matter how many rounds the rotor has turned the system can detect the absolute angular position of the rotor. It is possible that the sensor is not powered continuously, and the system is normally turned off after use, thus it is beneficial to have an absolute angular detecting system provides a robust system that does not need to be recalibrated every time the system is powered on. Furthermore, the first part can transmit electrical signals from one set of wires to another set of wires while the two sets of wires can rotate relative to each other without any of the wires getting twisted. The first part can advantageously be used in applications using the absolute angular position of a rotating object like a steering wheel of a car simulation or in robotics. For a simulation of a car, the driver turns the steering wheel and the simulation can provide feedback on the control of the steering wheel based on the angular measurements collected by the first part.

In an embodiment, the relative positioning of the magnetic sensor and the magnet is such that for all rotational positions of the magnet around the rotor axis, the sensor will detect a magnetic field from the magnet with a signal-to-noise-ratio above one.

By arranging the magnet and the magnetic sensor such that a signal from the magnet can be measured with a signal-to-noise-ratio above one it is ensured that the measured signal from the magnetic sensor is based on the magnetic field from the magnet and the angular detection is ensured to be based on a signal from the magnet and not random noise from other sources.

In an embodiment, the magnet may be connected physically to the rotor, such that the magnet and the rotor rotate undifferentiated.

By connecting the magnet to the rotor e.g., via a connecting element like a rod or beam, the magnet is ensured to rotate with the same angular speed as the rotor thus the angular detection is directly proportional for the rotor, the magnet and the set of one or more wires of the rotor. The magnet of the first part of the wheel base system may be mounted on a shaft of a motor, the shaft being connected to the rotor. Such mounting results in the magnet rotating in the same manner as the rotor of the first part and the magnetic sensor will detect the rotation of the rotor of the first part.

In an embodiment, the rotor comprises the magnet.

By having the rotor may comprise the magnet no connecting means for connecting the magnet to the rotor is needed.

In an embodiment, the stator comprises the magnetic sensor.

In an embodiment, the magnet is attached to a first rotor end, the first rotor end being the end of the rotor facing the magnetic sensor.

In an embodiment, the magnetic sensor is positioned on the rotor axis in a manner such that the rotor axis intersects with the magnetic sensor.

Having the magnetic sensor positioned such that the rotor axis intersects with the magnetic sensor, the magnetic sensor is placed at a central position on the stator. The central position renders the sensor capable of measuring the angle of a rotating magnet of the stator system.

The magnetic sensor measures at least the magnetic field strength along one axis which is denoted the sensor axis.

By having the magnetic sensor measuring the magnetic field along an axis, the system is capable of detecting an absolute angle. Additional magnetic sensors may be added to the system to be able to measure the magnetic field in other directions also. A magnetic sensor capable of measuring the magnetic field in three orthogonal directions may work as three one axis magnetic sensors coupled together.

In an embodiment, the magnetic sensor may be positioned on the rotor axis in a manner such that the rotor axis is perpendicularly or parallel to the sensor axis of the magnetic sensor.

By having the magnetic sensor positioned on the rotor axis in a manner such that the rotor axis is perpendicularly or parallel to the sensor axis of the magnetic sensor, it is ensured that the changes of the magnetic field from the magnet based on the rotation of the magnet can be detected by the sensor and result in an absolute angle of the magnet.

In an embodiment, the magnetic sensor is positioned off axis of the rotating axis of the driving shaft and the slip ring but in the same plane as the magnet, the plane being perpendicular to the rotating axis.

In an embodiment, the magnet is positioned on the rotor axis such that the rotor axis intersects with the magnet.

Having the magnet be positioned on the rotor axis such that the rotor axis intersects with the magnet ensures that the magnet is placed centrally on the first part.

In an embodiment, the magnet is positioned on the rotor axis such that a magnetization axis of the magnet is perpendicular to the rotor axis.

The magnetization axis of a magnet is the axis along the direction that most of the magnetic dipoles of the magnet are pointing along. Thus the magnetization axis is usually the axis going from the north pole of a magnet to the south pole and vice versa.

In an embodiment, the magnetic sensor and the magnet are arranged such that the rotor axis is passing through the symmetrical center or the center of mass of the magnet and the magnetic sensor.

The symmetrical center point of an object like a magnet can be overlapping with the center of mass of the magnet. Thus the symmetrical center point and the center of mass point may overlap. By positioning a center of the magnet and the magnetic sensor on the rotor axis it is ensured that for all positions of the magnet the magnetic field can be detected by the magnetic sensor. Furthermore the magnet will rotate around the rotor axis without any uneven movements such that any vibrations introduced by the rotation of the magnet are minimized.

In an embodiment, the magnetic sensor comprises a plurality of individual magnetic hall sensor units arranged in an array.

Using multiple magnetic sensors will provide a first part that can detect the angular position of the magnet with a higher precision.

In an embodiment, the magnetic sensor and the magnet are arranged such that at least a part of the area of the magnet projected onto the magnetic sensor along the rotor axis is for any position of the rotor encompassed by the area of the magnetic sensor.

In an embodiment, the magnetic sensor and the magnet are arranged such that the entirety of the area of the magnet projected onto the magnetic sensor along the rotor axis is encompassed by the area of the array of magnetic sensor units.

In an embodiment, the magnet is a disc magnet magnetized diametrically.

In an embodiment, the magnet is a ring magnet diametrically magnetized.

In an embodiment, the magnetic sensor is a hall sensor.

In an embodiment, the magnet and magnetic sensor is positioned within a distance of each other of 5 cm or 4 cm or 3 cm or 2 cm or 1 cm or 5 mm, or 2 mm or 1 mm or 0.5 mm or 0.1 mm.

By having a maximum distance between the magnet and the magnetic sensor it is ensured that the signal from the magnet is clear and constitutes the main part of the signal detected by the magnetic sensor.

In an embodiment, the magnet and magnetic sensor are positioned adjacent to each other with no objects arranged between them.

In an embodiment, the first part may comprise a printed circuit board (PCB), the PCB may be arranged statically relative to the rotor axis, and the magnetic sensor may be integrated on the PCB.

In an embodiment, the PCB is part of the stator by fastening means such that it can be fastened and removed.

By the first part comprising a PCB the magnetic sensor is easily connected to processing means via the PCB. The PCB may be removed and replaced if desired which makes the system capable of swapping the magnetic sensor if a better resolution of the magnetic sensor is desired or the magnetic sensor is broken. Thus only part of the first part needs to be replaced when e.g. an upgrade is performed.

In an embodiment, the slip ring is a drum type slip ring or a pancake slip ring or a through bore slip ring or a mercury wetted slip ring or a wireless slip ring.

In an embodiment, the first set of one or more wires and the second set of one or more wires comprise 2 wires or 3 wires or 4 wires or 5 wires each.

In an embodiment the slip ring is configured to support USB connections.

In an embodiment the slip ring further comprises a processor.

In an embodiment the processor is connected to the magnetic sensor either by wires or wirelessly.

In an embodiment the processor is positioned fixedly relative to the magnetic sensor and the processor is electrically connected to the magnetic sensor by wires.

By positioning the processor fixed relative to the magnetic sensor no extra brushes are needed in the slip ring in order to connect the sensor to the processor making the system more robust.

In an embodiment the rotor is fastened to a driving shaft of a motor and the stator is fastened to the static part of the motor.

In an embodiment the first part is part of a wheel base system. The wheel base system comprises a motor and the first part.

In an embodiment the motor is a motor of a wheel base for sim racing.

By sim racing is understood simulation of vehicle driving, the vehicle preferably being a race car.

In an embodiment the wheel base comprises a coupler for coupling to a steering wheel. Thereby, any steering wheel can be connected and the position of the steering wheel can be detected system.

The wheel base system may comprise a steering wheel that is coupled to the driving shaft of the motor via the coupler.

In an embodiment a steering wheel is connected to the driving shaft of the motor.

By connecting a steering wheel and the shaft of a wheel base to the rotor the angular measurements of the rotor are also measurements of the steering wheel, and can be used for a simulation of a car.

In an embodiment the motor can produce a torque of more than 1 Nm or 2 Nm or 4 Nm or 6 Nm or 8 Nm or 10 Nm or 12 Nm.

In an embodiment the slip ring comprises electrical shielding.

In an embodiment the shielding is a metal film surrounding the electrical parts of the slip ring.

By a metal film surrounding an object is meant a metal film having a surface that is a closed loop around the object as e.g. a hollow cylinder. The surface of the metal film may need to have a length along the electrical part the surface is enclosing, the length being at least half of the length of the first part.

By having shielding of the first part the quality of the signals transmitted through the first part is improved. When wires are spread physically out in a slip ring the wires are more susceptible to noise. Most of the signals like electromagnetic waves affecting the first part is absorbed by the shielding and thus the signals, which the first part is meant to transmit, can be transmitted undisturbed.

A fourth aspect of the present disclosure is a first part of a wheel base system comprising a rotor comprising a first set of one or more electrical conducting wires and a magnet, the rotor arranged to rotate around a rotor axis, a stator comprising a second set of one or more electrical conducting wires and a magnetic sensor. At least one wire of the first set of one or more electrical conducting wires being electrically connected to a wire of the second set of one or more electrical conducting wires. The magnetic sensor detects the absolute angular position of the rotor, thereby being an absolute magnetic encoder.

A fifth aspect of the present disclosure is a first part of a wheel base comprising a rotor comprising a first set of one or more electrical conducting wires and a magnet, the rotor arranged to rotate around a rotor axis, a stator comprising a second set of one or more electrical conducting wires and a magnetic sensor. At least one wire of the first set of one or more electrical conducting wires being electrically connected to a wire of the second set of one or more electrical conducting wires. The magnetic sensor may be positioned on the rotor axis in a manner such that the rotor axis intersects with the magnetic sensor. The magnet being arranged at a first rotor end, the first rotor end being the end of the rotor facing the magnetic sensor.

A sixth aspect of the present disclosure is a method for detecting the angle of a rotating part of a first part of a wheel base system according to the third aspect comprising the steps of the magnetic sensor measuring the magnetic field strength of the magnet of the first part and transmitting the collected data signal to a processor, based on the signal determining an angular position of the magnet.

In an embodiment the method further comprises the step of providing feedback in a simulation based on the signal and angular position.

In an embodiment the simulation is a simulation for driving a car.

In an embodiment the method further comprises the step of providing feedback in a simulation based on the signal.

In the following specific examples according to aspects of the present disclosure will be explained in more detail with reference to the accompanying drawings. The present disclosure may, however, be embodied in different forms than depicted below, and should not be construed as limited to any examples set forth herein. Rather, any examples are provided so that the disclosure will be thorough and complete, and will fully convey the scope of the invention to those skilled in the art. Like reference numerals refer to like elements throughout. Like elements will, thus, not be described in detail with respect to the description of each figure.

### BRIEF DESCRIPTION OF THE DRAWINGS

FIG. 1 illustrates part of a wheel base system with an on-axis magnetic sensor. The stator of the wheel base system is shown in a cross-sectional view.

FIG. 2 illustrates part of a wheel base system comprising an on-axis magnetic sensor. The stator of the wheel base system is shown in a cross-sectional view.

FIG. 3 illustrates part of a wheel base system with a magnetic sensor from the rotor side. The stator of the wheel base system is shown in a cross-sectional view.

FIG. 4 illustrates part of a wheel base system with a magnetic sensor on the surface of the stator facing away from the rotor. The stator of the wheel base system is shown in a cross-sectional view.

FIG. 5 illustrates a zoom of the area with the magnet and the magnetic sensor of the wheel base system illustrated in FIG. 4.

FIG. 6 illustrates part of a wheel base system of the pancake type with a magnetic sensor.

FIG. 7 illustrates a steering wheel and a wheel base system for simulation racing comprising a slip ring and an on-axis magnetic encoder.

FIG. 8 illustrates part of a wheel base system including a slip ring of the pancake type with an on-axis magnetic encoder.

FIG. 9 illustrates a cross-section of a wheel base system.

FIG. 10 illustrates a cross-section of a zoom of the slip ring and magnetic encoder of a wheel base system.

### DETAILED DESCRIPTION OF THE DISCLOSURE

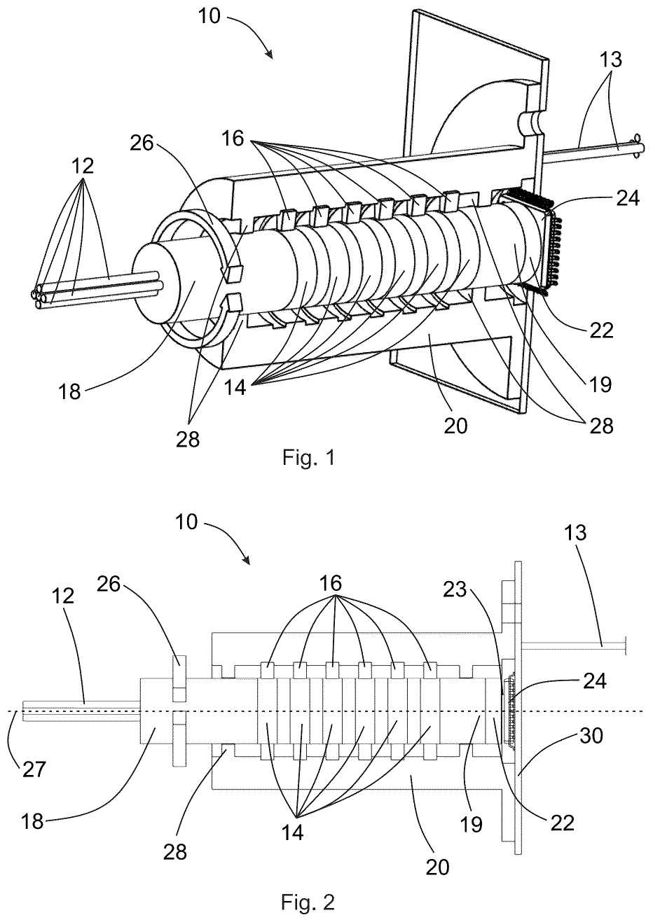

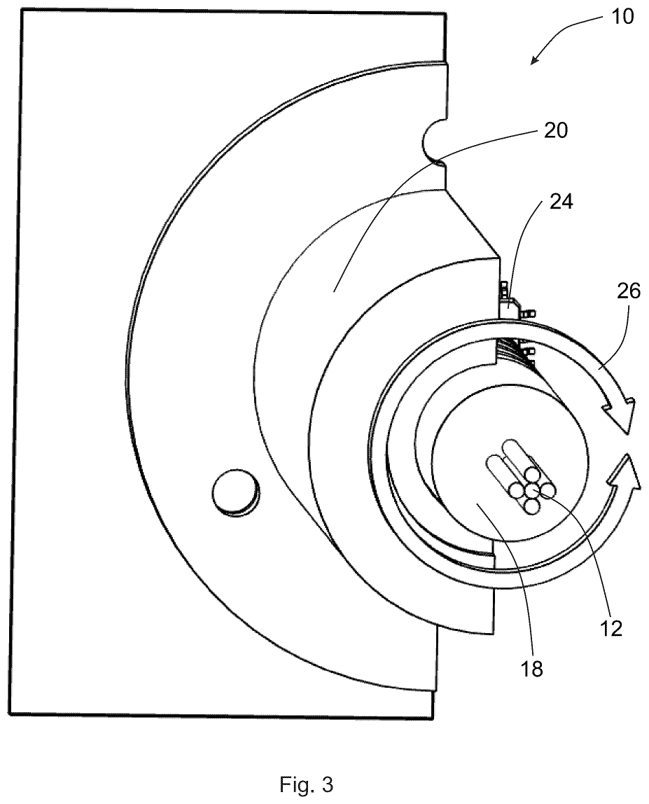

A first part 10 of a wheel base system is illustrated in FIG. 1. The first part 10 of the wheel base system comprises a rotor 18, a stator 20, elements of a slip ring, and a magnetic sensor 24. The rotor 18 has a first end 19. The slip ring can transport current/signals from a first set of one or more electrical conducting wires 12 of the rotor 18 to a second set of one or more electrical conducting wires 13 of the stator 20. The first set of one or more electrically conducting wires 12 will also be denoted the first set of one or more wires 12. The second set of one or more electrically conducting wires 13 will also be denoted the second set of one or more wires 13. The signals may constitute a USB signal, a UART signal, an I2C signal, a SPI signal, or a similar standard signal. The rotor 18 comprises a first set of one or more electrical conducting wires 12. The stator comprises a second set of one or more electrical conducting wires 13. The stator 20 and the rotor 18 can rotate relative to each other around a rotor axis (27 see FIG. 2) illustrated by the arrow 26. It may be that the stator 20 is fixed and the rotor 18 is able to rotate. In another configuration the rotor may be fixed and the stator may be able to rotate. Thus features described as belonging to the rotor may also be used on the stator and vice versa. The first set of one or more electrical conducting wires 12 of the rotor and the second set of one or more wires 13 of the stator are always connected electrically.

The wheel base system may comprise the parts of a slip ring and any further parts used in combination with the a slip ring to detect the movement of the slip ring in accordance with the invention. In some embodiments, the additional components may be an integrated part of the wheel base system, in other embodiments, the additional components of the wheel base system may be arranged relative to the slip ring elements. The slip ring elements of the wheel base system may be called a rotary collector ring, an electrical slip ring, an electrical swivel, or a collector ring comprising. The slip ring elements may be of any type of a slip ring, e.g. a drum slip ring, a through bore slip ring, a pancake slip ring, a mercury wetted slip ring, or a wireless slip ring also named a rotary transformer. Having slip ring elements being of a type of slip rings is meant that the slip ring elements are arranged according to the slip ring type. The slip ring illustrated in FIG. 1 is of the drum slip ring type. Each slip ring type may have its own advantages. The drum type can transfer a lot of electrical power. The pancake slip ring can be constructed as a very thin device. The wireless slip ring does not rely on friction to create electrical connections and therefore has a longer lifetime.

For the case where the slip ring elements of the wheel base system work as a through bore slip ring any cylinder or shaft may be placed inside the empty core of the slip ring and connected to the rotor 18 of the slip ring. The magnet of the wheel base system may be placed on the end of the cylinder or the shaft that is facing the magnetic sensor.

The wheel base system may comprise one or more bearings 28 such that the rotor and stator may rotate relative to each other with a minimum of friction between the stator and the rotor. The bearing 28 may be of any desired quality and size. It may be a ball bearing or a simple plain bearing or a slide bearing.

The individual wires of the first set of one or more wires 12 entering the rotor 18 of the wheel base system are electrically connected to a corresponding electrically conducting ring 14. The first set of one or more wires 12 may run inside the drum and connect to the rings from the inside. The slip ring elements may have only one conducting ring in which case the wire may be connected inside the rotor 18, on the surface of the rotor 18, or outside the rotor 18. A wheel base system may have arbitrarily many wires and conductive rings. Furthermore, a wire may be connected to multiple conductive rings 14 e.g. if a large amount of power needs to be conducted through the slip ring elements. The conductive rings 14 may likewise have a width matching the maximum power that needs to be transmitted through that connection of the slip ring. The one or more conductive rings 14 may have different widths which may result in the conductive rings having different maxima of transfer power depending on the width of each ring and a corresponding brush 16. The number of wires in the first set of one or more wires 12 may be different from the number of conductive rings 14.

A slip ring of the contact type comprises brushes 16. A brush 16 is fastened to the stator 20 such that it is in electrical connection with a wire of the second set of one or more wires 13 of the stator. Moreover, the brush 16 is arranged to contact a conductive ring of the rotor 18 and create an electrical connection between the brush 16 and the conductive ring 14. The electrical connection between the brush 16 and a conductive ring 14 has a maximum amount of power that can be transmitted. The rotating speed of the rotor 18 may not affect the maximum power of transmittance. The brushes 16 may be placed in multiple configurations in order to brush the conductive ring 14 and establish an electrical connection between the conductive ring 14 and the brush 16. The brush may be placed on a spring that pushes the brush 16 onto the conductive ring 14. The brush 16 may be formed as a spring itself. There may be multiple brushes 16 for each conductive ring 14. The brushes may be configured like any standard configuration for any standard slip ring.

The one or more brushes 16 are made of an electrically conducting material. The material may be metal like copper, silver, gold, aluminum, iron, nickel, zinc. The material may be a carbon based material like graphite, graphene, carbon nanotubes, or a composite material.

The one or more brushes 16 are electrically connected to the second set of one or more wires 13 of the stator 20 and exiting the stator 20. By using brushes and conductive rings the first set of one or more wires 12 entering the wheel base system through the rotor 18 is electrically connected through the wheel base system to the second set of one or more wires 13 of the stator 20 exiting the wheel base system. The same number of wires may enter and exit the wheel base system. Wires of the first set of one or more wires 12 or of the second set of one or more wires 13 may be combined or split inside the wheel base system and thereby more or fewer wires than entering the wheel base system may exit the wheel base system.

In another configuration of the wheel base system the conductive rings 14 are placed on the stator and the brushes 16 are placed on the rotor.

The first set of one or more wires 12 in the rotor 18 are as described above electrically connected to the second set of one or more wires 13 exiting the stator 20 through the conductive rings 14 and brushes 16. The first set of one or more wires 12 of the rotor 18 may rotate independently of the second set of one or more wires 13 of the stator 20.

The slip ring elements may be designed to handle a current and voltage used for transmitting electrical signals of a steering wheel and may include signals for a display and/or buttons.

The wheel base system further comprises a magnet 22 and a magnetic sensor 24. The magnetic sensor 24 may work as a magnetic encoder. The magnetic sensor 24 is capable of measuring the strength of a magnetic field at least in one direction, the direction along which the sensor is measuring the magnetic field strength is denoted the sensor axis. A magnetic encoder comprises one or more magnetic sensors for measuring changes of a magnetic field and transferring the magnetic field strength measurement into an electrical signal comprising information about the position of a magnet or an object. The magnet may be fastened to an object like a rotor of a wheel base and/or a slip ring, a stator of a slip ring, or a steering wheel of a setup for simulations of driving a vehicle. The encoder may provide information about the rotation angle of the object. The magnet 22 is placed on the rotor 18 and the magnetic sensor 24 is placed on the stator 20.

The magnet 22 may be arranged with different orientations and positions on the rotor 18. The magnet 22 may be placed on the rotor axis 27 (see FIG. 2) of the rotor 18. The magnet 22 may be placed on the end of the rotor 18 that is facing the stator 20 or within 2 mm, 4 mm, 6 mm, 8 mm, 1 cm, 2 cm, or 3 cm s of the rotor end. The magnet may be of any type e.g. a permanent magnet or an electromagnet. The magnet 22 may have any appropriate shape e.g. a disk magnet, a cube magnet, a bar magnet, a sphere magnet, a horseshoe magnet or a ring magnet. The magnet 22 may be magnetized in any appropriate configuration e.g. diametrical magnetization, axial magnetization, radial magnetization, or segmental magnetization. There may be more than one magnet positioned on the rotor. The purpose of the magnet 22 is among other things to indicate the position of the rotor as the magnetic field produced by the magnet 22 will rotate with the same speed and angular position as the rotor 18. If the magnet 22 is a diametrically magnetized disk magnet it may be positioned on the rotor axis 27 of the rotor 18 in such a way that the center of the disk magnet is aligned with the rotor axis 27 of the rotor 18. The magnetic field produced by the magnet 22 may thereby be normal to the rotor axis 27 of the wheel base system along all of the rotor axis 27.

By positioning or placing an object, such as a magnet, on a first axis is meant that the first axis intersect with the element. An axis intersects with an object when the axis is passing physically through the object or when the object surrounds the axis, e.g. given when the axis is passing through a hole in the object. The object may further rotate around a rotation axis being parallel and overlapping with the first axis. The first axis may further be specified to be an axis passing through the center of mass of the element or through an axis of symmetry of the element. The arrangement of an element relative to an axis is here described as a mathematical concept, the person skilled in the art will understand that in physical systems such as for the rotor, stator and wheel base system according to the invention limitations of production and assembly may cause slight offsets of mounting of elements relative to the intended axis.

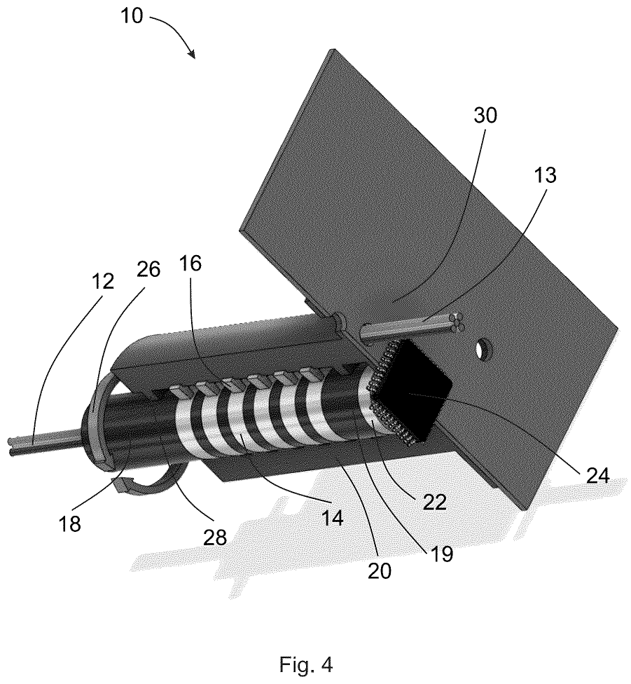

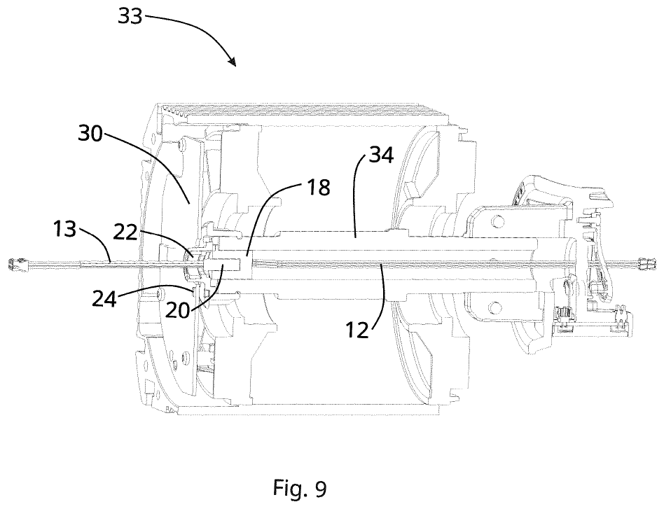

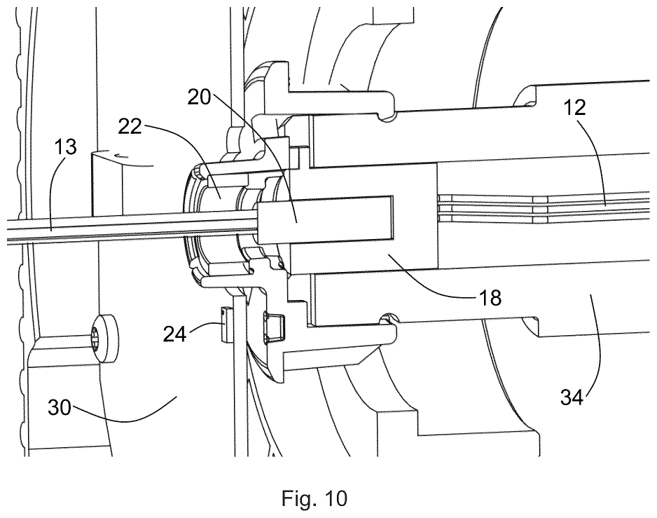

In all embodiments of the invention the stator 20 comprises a magnetic sensor 24. The magnetic sensor 24 may function as a magnetic encoder. The magnetic sensor 24 is arranged such that it can measure the magnetic field from the magnet 22 and thereby detect the position of the rotor 18. The position detected may be the rotation angle between the stator 20 and the rotor 18. The magnetic sensor 24 may be placed on the rotor axis 27 of the wheel base system or within a distance below 5 cm or 4 cm or 3 cm or 2 cm or 1 cm or 8 mm or 5 mm, or 2 mm or 1 mm or 0.5 mm or 0.1 mm of the rotor axis 27. The magnetic sensor 24 may be positioned off-axis relative to the magnet as illustrated in FIGS. 9 and 10. The magnetic sensor 24 may be placed on the surface of the stator 20 facing the end of the rotor 18 as shown in FIG. 1 to arrange the magnetic sensor 24 close to the magnet. The magnetic sensor 24 may be placed on the surface of the stator 20 facing away from the end of the rotor 18 as shown in FIG. 4. The magnetic sensor 24 may be embedded inside the stator 20 with layers of material between the magnetic sensor 24 and the rotor 18. The layers between the magnetic sensor 24 and the rotor 18 may be a static part of the stator 20, like the housing or the PCB. The magnetic encoder may be either an absolute encoder or an incremental encoder. An absolute encoder is preferred as an absolute magnetic encoder does not need a calibration between every use of the wheel base system.

The wheel base system may comprise additional magnetic sensors. The one or more magnetic sensors may be hall sensors or variable reluctance sensors to measure the present magnetic field and how the magnetic field changes. The measured quantity may be the magnitude of the magnetic field in a specific direction or in multiple directions.

The magnetic sensor 24 and the magnet 22 are preferably placed within a distance of each other such that the magnetic field of the magnet 22 can be measured by the magnetic sensor 24. The magnetic sensor 24 can detect a magnet if the signal from the magnet can be distinguished from noise. The magnet 22 and magnetic sensor 24 may be configured such that they are spaced apart in order to reduce friction and wear of these elements; such a configuration is shown in FIG. 2. The magnet and magnetic sensor may be within a distance of 10 cm, 5 cm, 4 cm, 3 cm, 2 cm, 1 cm, 8 mm, 5 mm, 4 mm, 3 mm, 2, mm, 1 mm, 0.5 mm or 0.1 mm of each other.

The stator 20 may include a printed circuit board (PCB) 30 as shown in FIG. 2. FIG. 2 illustrates part of a wheel base system where the stator is shown in a cross-sectional view. The magnetic sensor 24 may be connected to the PCB 30 and arranged on the surface thereof. The PCB 30 may be attached releasably by attaching means to the stator 20. The PCB may be fastened to the stator by screws, clips, glue, or the like. By using a PCB the magnetic sensor may easily be connected to a processor. The magnetic sensor 24 and the PCB may easily be replaced if broken or another cheaper or more precise magnetic sensor 24 is desired. If the magnetic sensor is broken or to be replaced, the magnetic sensor may be replaced without replacing the PCB. The PCB may include other components like resistors, contacts, capacitors, indicators, and the like. The PCB may comprise an integrated circuit designed for a magnetic sensor 24 so a processor may be connected directly to the PCB or connected via a control module. The wires of the wheel base system may go through the PCB either integrated or through a hole.

The PCB may be fastened to the stator of the wheel base system though the electrical pins connecting the wires and the magnetic sensor. These electrical pins may be standard pins for connecting wires to a PCB by soldering the pins to the PCB through a hole in the PCB. The pins connected may be spread out over the plane of the PCB or collected in one area to provide the best signal integrity possible. Other pins may be connected to the PCB to give mechanical support to the PCB. The PCB may be fastened via the electrical pins in such a fashion that no other fastening means are required. The PCB may be fastened with screws or bolts.

In another embodiment the wheel base system may comprise an absolute optic encoder for detecting the position of the rotor. The detected position may be the angle of the rotor. The optical encoder may be placed on the rotor axis 27 of the wheel base system. The optical encoder may replace the magnetic sensor 24 described in this document by further replacing the magnet 22 with a light source. The optical encoder may be added to the wheel base system as an additional encoder to the magnetic encoder.

A first part of the wheel base system 10 is illustrated in FIG. 3 where half of the stator 20 of the wheel base system is not shown. The rotor 18 of the wheel base system has a rotor axis 27 the rotation around which is indicated by the arrow 26 and it is clearly seen that the first set of one or wires 12 connected to the rotor 18 may rotate freely compared to the stator 20.

FIG. 4 illustrates part of an embodiment of the wheel base system where the magnetic sensor 24 is placed on the surface of the stator 20 that is normal to the rotor axis 27 of the wheel base system and the magnetic sensor 24 is facing the stator 20. The magnetic sensor 24 may be connected to a PCB 30 such that the sensor may be connected to other components like a processor, a display, and/or a controller. The sensor and/or the PCB 30 may be fastened to the stator by fastening means, e.g. screws, nail, solder, glue, clips, snaps, or bolts. Fastening the PCB to the stator ensures that the magnetic sensor 24 is easy to replace if damaged or a new sensor is required.

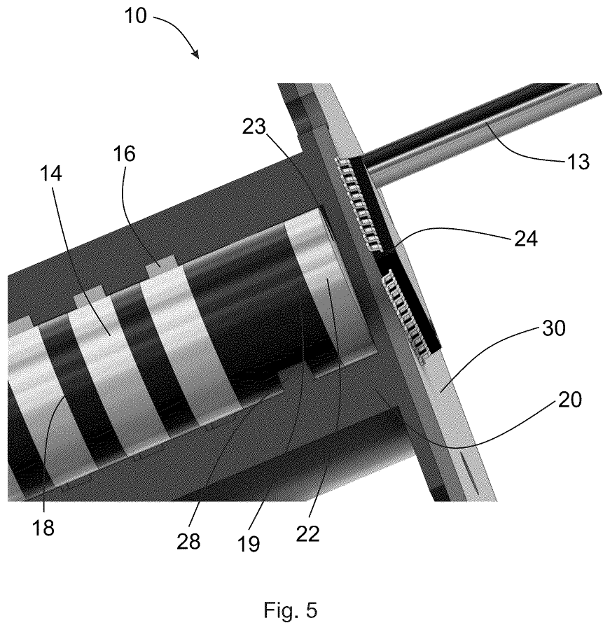

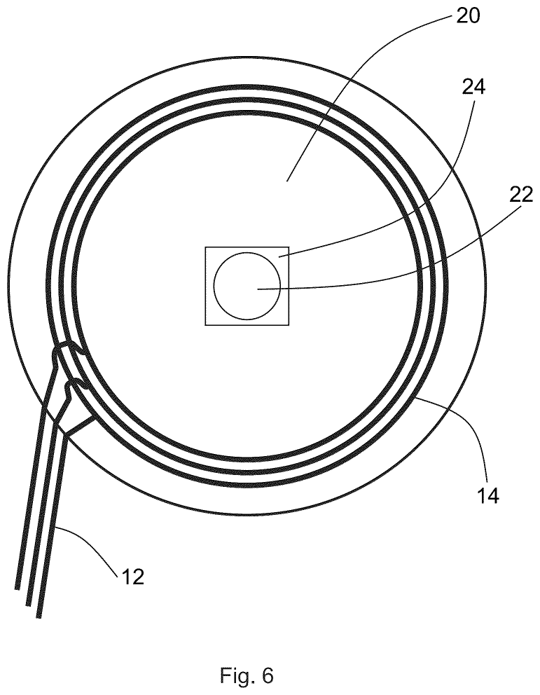

FIG. 5 illustrates a first part 10 of an embodiment of the wheel base system. The magnetic sensor 24 is placed with layers of materials like the PCB layer or the housing of the slip ring between the magnet 22 and the magnetic sensor 24. These layers may be configured to influence a magnetic field as little as possible. There is a gap 23 between the magnet 22 and the stator as these two surfaces may rotate arbitrarily relative to each other. In one embodiment the layers between the magnet 22 and the magnetic sensor 24 are made of materials that amplify the magnetic field of the magnet 22. The stator may be made of materials that do not influence the magnetic field and response of the magnet 22 or the magnetic sensor 24 as a stator of non-magnetic responsive material may increase the precision of the magnetic sensor and the measurement of the position of the rotor 18. One of the layers may be a PCB 30 for connecting the magnetic sensor 24.

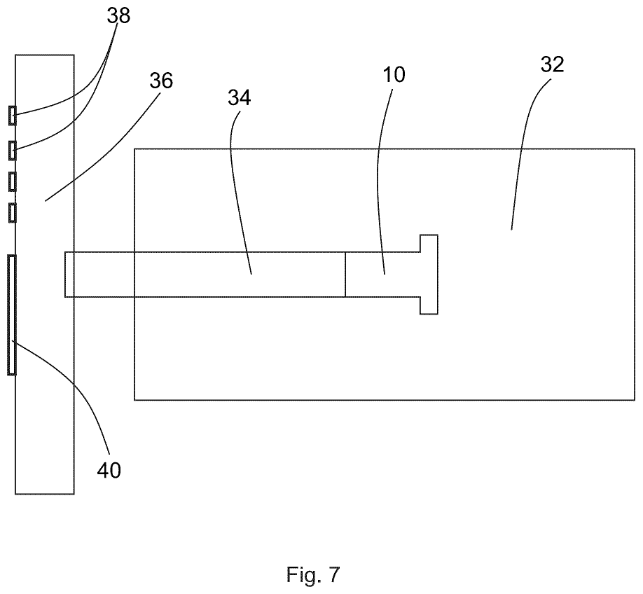

In an embodiment the slip ring elements are of the pancake type as shown in FIG. 6. FIG. 6 illustrates part of a wheel base system with slip ring elements of the pancake type and seen from one end of the rotor axis 27. The conductive rings 14 and the first set of one or more wires 12 are illustrated by thick black lines. The conductive rings and the brushes (not shown) may connect the wires (not shown) of the stator 20 to the wires of the rotor 18. The conductive rings 14 are placed as circles with different diameters. The magnet 22 and magnetic sensor 24 are placed on the rotor axis 27 of the wheel base system.

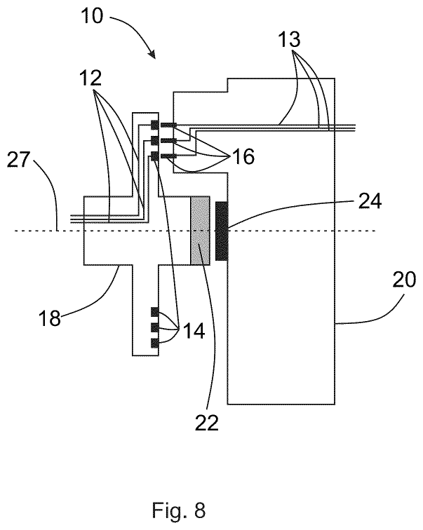

FIG. 8 illustrates a cross section of part of a wheel base system with a magnetic sensor 24, the slip ring elements are of the type of a pancake slip ring. The brushes of the wheel base system are placed in a plane normal to the rotor axis 27 of the wheel base system. Likewise the conductive rings are electrically connected to the brushes of the stator and the first set of one or more wires 12 of the rotor 18 may be arranged in a plane normal to the rotor axis 27 of the wheel base system, the plane is adjacent to the plane of the brushes with a spacing such that the brushes contact the conducting rings during operation of the wheel base system. Part of the housing of the stator and rotor is not shown. The housing ensures that the rotor and stator stay in place compared to each other. The conductive rings 14 may be circular around the rotor axis, and as a cross section is illustrated there are two parts of the conductive rings 14 visible in FIG. 8. The magnet and the magnetic sensor are aligned and may be placed adjacent to each other.

The wheel base system may include a processor for receiving a position measurement from the magnetic sensor. The position measurement may be used by the processor to control a motor. The processor may be positioned such that it is fixed compared to the magnetic sensor 24 such that no additional slip ring or additional electrical connections through a slip are needed to connect the processor and the magnetic sensor as the magnetic sensor does not rotate compared to the processor. If the magnetic sensor was placed on the rotor 18 of the wheel base system, connections to the processor would have to go through the slip ring elements, resulting in the slip ring elements comprising more connections which would make the connection to the magnetic sensor more complicated and not as durable. Moreover the signal would be more exposed and the signal integrity will decrease when the wires are spread out as in a slip ring. Spreading out wires transmitting signals spatially could introduce more noise in the signals of the wires.

The wheel base system may comprise shielding to protect the signal integrity of the signals carried by the wires. The shielding may prevent electrical fields from affecting electrical signals carried by the wires or conductive rings of the wheel base system. The shielding may comprise a layer that is surrounding the slip ring elements. The shielding may surround the slip ring elements completely or partly. The shielding may be split into multiple parts. The rotor may comprise a part of the shielding and the stator may comprise another part of the shielding. The shielding may be comprised of a metal layer. The metal layer may be comprised of one metal, multiple metals, or a mix of metals in an alloy. The metal layer may be a metal film and may damp electrical and/or magnetic fields and or electromagnetic waves. The metal film may be placed as close as possible to the wires, brushes and conductive rings without touching. The metal film may be placed within the surface of the rotor and the stator and thus be integrated in the rotor and the stator. The metal film may be placed on the outside of the rotor and the stator possibly as a coating. The metal film may be comprised in the housing of the wheel base system.

The different components of the wheel base system may be assembled in a modular way such that the single components can be replaced independently. For example, the magnetic sensor may be removed from the PCB and a new sensor may be installed or the PCB is replaced with a PCB having a new magnetic sensor. Other parts to replace may be the magnet, the brushes, the conductive rings, or the bearings. Arranging and designing the wheel base system such that elements like the previous mentioned elements can be replaced individually provide a modularity of the wheel base system. The wheel base system may thereby become customizable and cheaper to repair.

Having a wheel base system as described makes it possible to transfer electrical signals from a first set of one or more wires 12 connected to the rotor 18 to a second set of one or more wires 13 connected to a stator 20 while the wires may rotate arbitrarily to each other. Adding a magnet 22 and a magnetic sensor 24 to the wheel base system further provides a position detection in the system. The relative position of the stator 20 and the rotor 18 may be measured and used in an application.

The wheel base system according to the invention may be used in any simulation racing application where electrical signals of a steering wheel need to be communicated to a processing unit.

The wheel base system is designed for coupling to a steering wheel such that the wheel base system can be used in simulations. FIG. 7 illustrates a steering wheel 36 and a wheel base system. The steering wheel may comprise buttons 38 and a display 40 for a user to interact with a simulation software. Simulation wheel bases have as standard a motor 32 with a driving shaft 34. A processor connected to the magnetic sensor may control the simulation by further being connected to at least a pedal and a display. The magnet 22 and the magnetic sensor 24 may make it possible for the system to measure the position of the steering wheel compared to the stationary part of the wheel base system. The magnetic sensor 24 may therefore be connected to the processor and supply the processor with the position measurement to be used for the simulation. The processor may be controlling the motor of the wheel base based on a simulation. The wheel base system may be used in sim racing and training of drivers. Using a magnet 22 and a magnetic sensor 24 to measure the angle or position of a steering wheel is an easy and cheap solution for detecting the angle of a steering wheel. Furthermore, the sensor may be replaced if damaged or an upgrade needs to be installed allowing the rest of the wheel base system to stay usable and not be replaced. When fabricating the wheel base system, the orientation of the magnet may not be known. The setup may be calibrated to find the position of the magnet and thereby be able to determine the position of a steering wheel. The calibration may be performed once and the wheel base system will be calibrated until the position of the magnet or the sensor is adjusted. The calibration may be performed one or more times when a user desires or when an element has been replaced.

The wheel base system may be designed to comprise a motor capable of producing a torque of more than 1 Nm or 2 Nm or 4 Nm or 6 Nm or 8 Nm or 10 Nm or 12 Nm. The motor may have a maximum torque of 22 Nm, 25 Nm, 30 Nm, or 35 Nm. These torques are optimal for sim racing and may match the force a driver may exert on a steering wheel.

FIG. 9 illustrates a cross-section of a wheel base system 33 comprising a slip ring and a magnetic encoder. The wheel base may comprise a motor for rotating the rotor of the motor 32 and wheel base. The rotor 34 may comprise a coupler for coupling the rotor to a steering wheel. The wheel base system is engineered for simulation of driving a vehicle. Thus, the motor 32 of the wheel base is performing the effect of creating resistance of rotating a steering wheel.

The slip ring of the wheel base system may be positioned at the end of the driving shaft of the motor opposite the coupler to the steering wheel. The slip ring may be a cylindrical slip ring as this is standard and easier to fabricate and position in the wheel base system. A cylindrical slip ring/drum type slip ring as illustrated in FIG. 9 provides the electrical wires along the rotation axis. The slip ring may be positioned at any position along the driving shaft. The driving shaft may be hollow and the slip may be positioned inside the driving shaft to provide a compact wheel base system.

If the slip ring is positioned along the rotating axis of the driving shaft the magnet may be a ring magnet. The ring magnet may be diametrically magnetized. The magnet may be positioned at the end of the driving shaft opposite a potential coupler to a steering wheel. When a ring magnet the magnet may provide space for electrical wires running through the center of the magnet. Having a ring magnet provides for easier manufacturing and assembly.

The magnet may be positioned away from the inducting coils of the motor 32 such that the magnetic field from the motor does not affect the magnetic field of the magnet for detecting the absolute angle of rotation of the driving shaft.

The magnet may preferably comprise two magnetic poles. This will provide a unique magnetic field when the magnetic sensor is positioned correctly. For a ring magnet the sensor is placed in the same plane as the magnet that is normal to the rotation axis of the magnet. The sensor is offset in that plane by a distance such that the sensor is close enough to detect the magnetic field of the magnet. The magnetic field of such a magnet at the position of the magnetic sensor will be unique in the way that every direction of the magnetic field detected by the sensor corresponds to a single absolute position of the magnet. In this manner the absolute angle of the magnet can be detected by the magnetic sensor.

To detect the absolute angle of rotation of the driving shaft a magnetic sensor 24 is placed in close proximity to the magnet 22. If the magnet is a ring magnet as illustrated in FIG. 9 the magnetic sensor may be positioned in a plane normal to the rotating axis of the driving shaft 34 and the plane going through the center of the magnet. Thus the magnetic sensor 24 may be positioned to the side of the ring magnet and thus off axis relative to the rotation axis of the slip ring and the driving shaft.

The magnetic sensor 24 and the magnet 22 is denoted a magnetic encoder. The magnetic encoder may comprise a computing unit to control the sensor and perform measurements to calculate the absolute angular position of the magnet.

A zoom in on the slip ring and the magnetic encoder illustrated in FIG. 9 can be seen in FIG. 10. The magnet 22 is illustrated as a ring magnet and the magnetic sensor 24 is position in a plane normal to the rotating axis of the driving shaft 34 and in the same plane as the magnet 22. The electrical wires 12 of the rotor 18 can rotate relative to the electrical wires 13 of the stator 20. The magnetic sensor may be placed on a PCB such that electrical connections to the sensor may be provided via the PCB.

Below is a list of reference signs used in the detailed description of the present disclosure and in the drawings referred to in the detailed description of the present disclosure.
10 First part of wheel base system
12 Electrical wire of rotor
13 Electrical wire of stator
14 Conductive rings
16 Brushes
18 Rotor
19 First rotor end
20 Stator
22 Magnet
23 Space between magnet and magnetic sensor
24 Magnetic sensor
26 Arrow illustrating a rotor axis of the rotor and the stator
27 Rotor axis of slip ring
28 Rotational means
30 Printed Circuit Board
32 Motor
33 Wheel base system
34 Driving shaft
36 Steering wheel
38 Button
40 Display

1. A wheel base system for simulation, the wheel base system comprising:
a motor comprising a rotor and a stator;
the rotor comprising a magnet and a first set of one or more electrical conducting wires, the rotor arranged to rotate around a rotor axis and rotate relative to the stator; and
the stator comprising a second set of one or more electrical conducting wires;
a magnetic sensor arranged statically relative to the stator;
at least one wire of the first set of one or more electrical conducting wires being electrically connected to a wire of the second set of one or more electrical conducting wires,
the magnetic sensor arranged to detect the absolute angular position of the magnet, the magnetic sensor thereby being an absolute magnetic encoder.

2. A wheel base system according to claim 1, wherein the center of the magnetic sensor is positioned with a distance to the rotor axis of maximum 20 mm.

3. A wheel base system according to claim 1, wherein the rotor comprises a coupler for connecting a steering wheel for simulation.

4. A wheel base system according to claim 3, wherein the wheel base system comprise a steering wheel coupled to the coupler of the rotor.

5. A wheel base system according to claim 1, wherein the first set of electrical conducting wires are connected to one or more buttons of the steering wheel.

6. A wheel base system according to claim 1, wherein the wheel base comprises a processing unit for controlling a simulation.

7. A wheel base system according to claim 1, wherein the magnetic sensor is positioned on the rotor axis in a manner such that the rotor axis intersects with the magnetic sensor.

8. A wheel base system according to claim 1, the magnetic sensor being positioned off axis of the rotor axis in a plane perpendicular to the rotor axis and intersecting the magnet.

9. A wheel base system according to claim 1, wherein the magnet is positioned on the rotor axis and positioned such that a magnetization axis of the magnet is perpendicular to the rotor axis.

10. A wheel base system according to claim 1, wherein the wheel base system comprising a plurality of individual magnetic hall sensors arranged in an array.

11. A wheel base system according to claim 1, wherein the magnetic sensor and the magnet being arranged such that at least a part of the area of the magnet projected onto the magnetic sensor along the rotor axis is for any position of the rotor encompassed by the area of the magnetic sensor.

12. A wheel base system according to claim 1, wherein the wheel base system comprises a PCB, the PCB being arranged statically relative to the rotor axis, the magnetic sensor being integrated on the PCB.

13. A wheel base system according to claim 1, wherein the slip ring comprising electrical shielding.

14. A method for detecting an angle of a rotor of a wheel base system, wherein the wheel base system comprises:
a motor comprising a rotor and a stator;
the rotor comprising a magnet and a first set of one or more electrical conducting wires, the rotor arranged to rotate around a rotor axis and rotate relative to the stator; and
the stator comprising a second set of one or more electrical conducting wires;
a magnetic sensor arranged statically relative to the stator;
at least one wire of the first set of one or more electrical conducting wires being electrically connected to a wire of the second set of one or more electrical conducting wires;
the magnetic sensor arranged to detect the absolute angular position of the magnet, the magnetic sensor thereby being an absolute magnetic encoder;
the method comprising the steps of:
the magnetic sensor measuring the magnetic field strength of the magnet of the wheel base system and transmitting collected data signal to a processor, and
based on the collected data signal determining an angular position of the magnet and the rotor.

15. A method according to claim 14, wherein the method further comprises the step of using the collected data signal to control a simulation of a vehicle.
